(19) United States
(12) Patent Application Publication
(10) Pub. No.: US 2017/0172232 A1
(43) Pub. Date: Jun. 22, 2017

(54) MULTIMETER INTEGRATED WITH A GLOVE

(71) Applicant: Bosch Automotive Service Solutions Inc., Warren, MI (US)

(72) Inventor: Jason J. Anderson, Portage, MI (US)

(21) Appl. No.: 14/976,523

(22) Filed: Dec. 21, 2015

(51) Int. Cl. A41D 19/00; G06F 3/041

(52) U.S. Cl. CPC A41D 19/0027; G06F 3/0416; A41D 2600/20

(57) ABSTRACT

A glove is provided. The glove includes: a palm portion; first and second fingers extending from the palm portion; a first probe attached to the first finger; a second probe attached to the second finger; connectors contained within the glove operatively connected to the first and second probes; and a display operatively connected to the first and second probe.

### FIELD OF THE INVENTION

The present invention relates generally to a multimeter or oscilloscope for use by automotive repair technicians. More particularly, the present invention relates to a glove with a multimeter and/or oscilloscope built into the glove.

### BACKGROUND

Automotive repair technicians currently use digital multimeters or oscilloscopes with external probes attached to a block or box which contains a readout display and selection switches. Unfortunately, the use of the external probes may require one hand and holding the box with the readout display may require the second hand. Furthermore, due to space or size constraints, it may be difficult for the automotive repair technician to manipulate the probes and order to achieve a useful readout.

Accordingly, it is desirable to provide a method and apparatus that allows automotive technicians to more easily manipulate the probes to achieve a useful readout for multimeters and/or oscilloscopes and, in some instances, require the use of only one hand.

### SUMMARY

The foregoing needs are met, to a great extent, by the present disclosure, wherein in one aspect an apparatus is provided that in some embodiments allows automotive technicians to more easily manipulate the probes to achieve a useful readout for multimeters and/or oscilloscopes and, in some instances, require the use of only one hand.

In accordance with one embodiment of the present disclosure, a glove is provided. The glove includes: a palm portion; first and second fingers extending from the palm portion; a first probe attached to the first finger; a second probe attached to the second finger; connectors contained within the glove operatively connected to the first and second probes; and a display operatively connected to the first and second probe.

In accordance with another embodiment of the present disclosure, a method of assembling an instrument is provided. The method includes: attaching a first and second probe to a glove; connecting the first and second probes to a controller; operatively connecting a display to the controller; operatively connecting an input device to the controller; and configuring the controller to operate the instrument as at least one of either a multimeter and an oscilloscope.

In accordance with yet another embodiment of the present disclosure, a glove is provided. The glove includes: a palm portion; first and second fingers extending from the palm portion; a first probe attached to the first finger; a second probe attached to the second finger; means for connecting the first and second probe to a controller, the means for connecting contained within the glove; and means for displaying data associated with the controller operatively connected to the controller.

There has thus been outlined, rather broadly, certain embodiments of the disclosure in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a glove in accordance with one embodiment of the present disclosure.

FIG. 2 is a schematic diagram illustrating the measuring system in accordance with an embodiment of the present disclosure.

### DETAILED DESCRIPTION

Various embodiments will now be described with reference to the drawing figures, in which like reference numerals refer to like parts throughout. An embodiment in accordance with the present disclosure provides a measuring system integrated with a glove to allow maintenance personnel or anyone else to perform the functions of the digital multimeter and or oscilloscope in a different manner than previously done. In some embodiments, a measuring apparatus such as a multimeter and/or oscilloscope are integrated with a glove to allow an automotive technician to put on the glove and place various probes or contacts at an appropriate place within a piece of equipment being maintained or serviced and readout various things being measured such as current, resistance, voltage, and etc., just by manipulating the operators gloved hand.

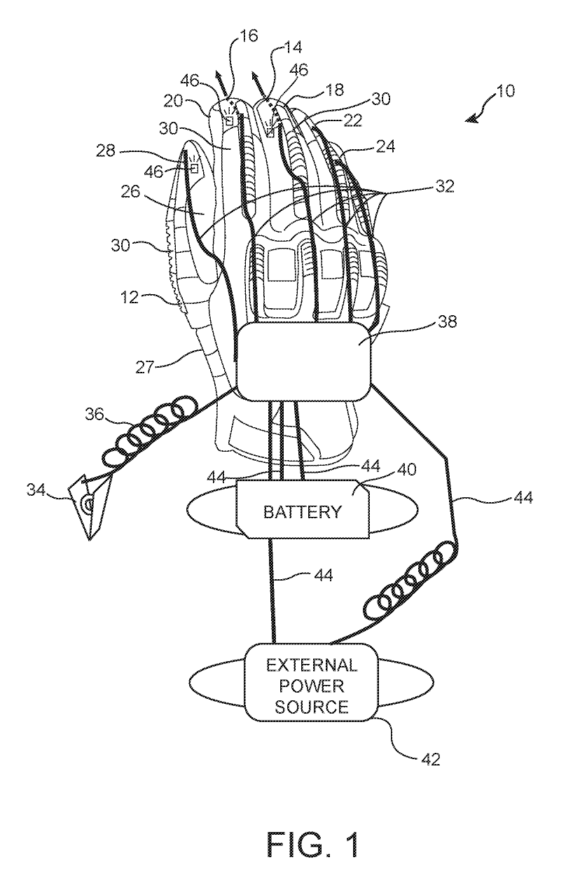

FIG. 1 illustrates a glove measuring system 10 in accordance with one embodiment. The glove measuring system 10 includes a glove 12. The glove 12 includes leads or probes 14 and 15 which are attached to the middle 18 and index fingers 20 respectively in the glove 12. The glove 12 also includes a ring finger 22, pinky 24, and thumb 26. The fingers 18, 20, 22, 24, and 26 all extend from a palm portion 27 of the glove 12. In other embodiments, the probes 14 and 15 maybe located in other fingers 22, 24, and 26 and are not limited to the middle finger 18 and index finger 20. While these documents may refer to first, second, and third fingers such numbered designations should not be limited to specific fingers (such as index finger, middle finger, and thumb, etc.). Rather, these numbered designations should refer to the fact at the globe 12 has multiple fingers and distinguishes one finger from another.

In some embodiments and as shown in FIG. 1, an inductive pickup 28 may be embedded in the palm portion 27 and/or one of the fingers, such as the thumb 26, of the glove 12. The glove 12 may be made of an electrically insulating material 30 which surrounds the internal wires 32 connecting the leads 14 and 16 and the inductive pickup 28.

It will be appreciated that the inductive pickup 28 and internal wires 32 are embedded within the glove 12. The internal inductive pickup 28 and the internal wires 32 are illustrated in FIG. 1 in order to show the reader these features, but it will be appreciated that the inductive pickup 28 and internal wires 32 are located within the insulating material 30 of the glove 12 and would not normally be visible from outside the glove 12.

Optionally lights 46 may be located on or integrated into the glove 12 and oriented to shine on the probes or leads 14 and 16. The lights 46 may assist the user in locating features of the machine being tested or serviced.

In some embodiments, an optional ground clamp 34 may be attached via an optional ground clamp connector 36 to a display 38 or some other electrical feature of the glove in order to ground the glove 10. The ground clamp 34 is used to connect to a ground prior to using the leads 14 and 16 or inductive pickup 28. Optionally, the ground clamp 34 could be used in the place of the finger ground which could be one of leads 14 or 16.

The display 28 may be operatively connected to the leads 14 and 16 and to the inductive pickup 28 in order to display values detected or measured by the leads 14, 16 and/or inductive pickup 28. The glove measuring system 10 may be powered by a battery 40. In other embodiments, some other type of power source 42, such as an external power source, may power the glove measuring system 10. The external power source 42 may be a DC or AC power source. Connectors 44 may connect the battery pack 40 or the other power sources 42 to the display 38.

In some embodiments, the battery 40 may be on a wristband that attaches to the arm of a user of the glove measuring system 10 so that the battery 40 may be located proximate to the glove measuring system 10.

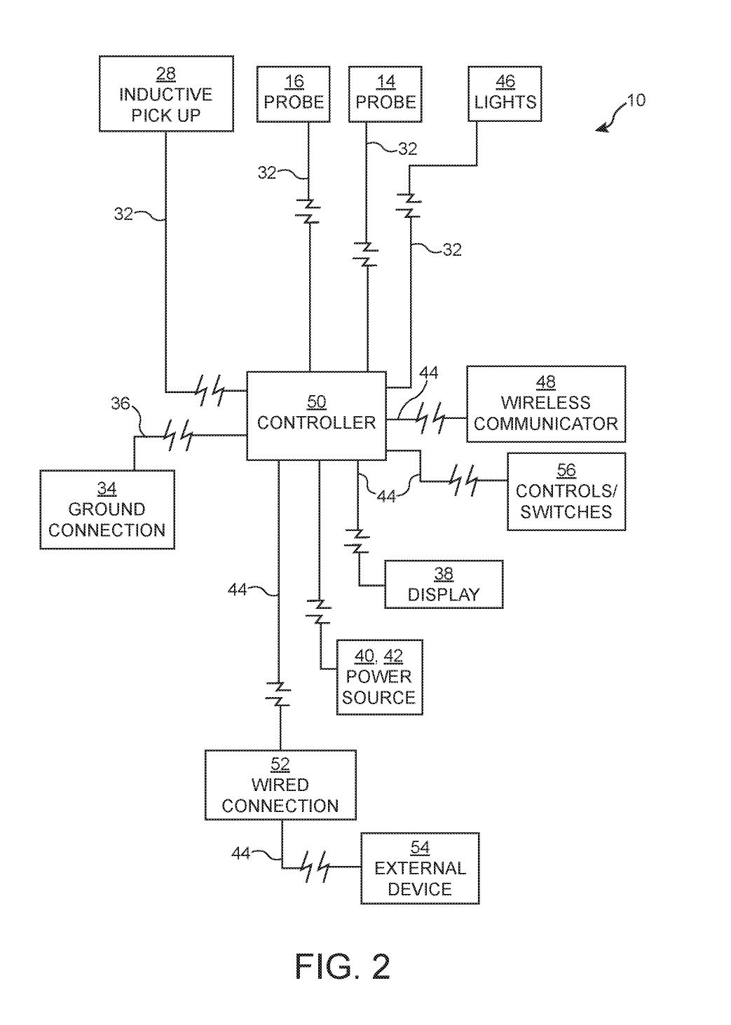

FIG. 2 is an illustrative schematic diagram of a generic glove measuring system 10 which may be in accordance with the glove measuring system 10 of FIG. 1 or other variants of the glove measuring system 10 in accordance with the present disclosure.

As shown in FIG. 2. The glove measuring system 10 may optionally include lights 46 and/or a wireless communicator 48 operatively connected to a controller 50. In some embodiments, the controller 50 may be a microcontroller 50 configured to operate the glove measuring system 10.

The lights 46 may be LED lights and may be useful in helping a user identify where to attach or connect the probes 14, and 16 when working in an engine compartment or other dark or only semi-lit space. The lights 46 may be attached to any of the fingers 18, 20, 22, 24, or 26 of the glove 12 and configured to shine on or just forward of the probes 14 and 16.

The wireless communicator 48 is an optional element which allows the controller 50 to communicate data received by the probes 14, 16 or inductive pickup 28 to an external device 54 or to display the data on the display 38. The display 38 may be located on the back of the glove 12 as shown in FIG. 1 and may include an illuminated LED screen or any other screen suitable for displaying data. In some embodiments, the display 38 maybe illuminated or otherwise configured to operate in low light conditions.

Optionally, the controller 52 may communicate data via the wireless communicator 48 or a wired connection 52 to an external device 54. The external device 54 may be a computer, a remotely located display screen, laptop computer, notebook computer, a smart phone, a dedicated tool or any other suitable device for displaying and/or saving any data sent by the controller 50. In addition to, or in lieu of, a wired connection 52, the wireless communicator 54 may transmit data via Bluetooth, Wi-Fi, or any other suitable wireless communication protocol.

In some embodiments and as illustrated in FIG. 2, an exterior control or switch panel 56 is operatively connected to the controller 50. The switches or controls 56 allow a user to operate the glove measuring system 10. In some embodiments the switches or controls 56 may be located on the glove 12. In other embodiments the switches or controls 56 may be located off of the glove. In some embodiments the controller switches 56 may be integrated with the display 38. In instances where the display 38 is a touchscreen, the control of the glove measuring system 10 may be accomplished by touching the display screen 38. In other embodiments the control switches 56 may be actual buttons or other actuated items that may be located on the display 38, or elsewhere on the glove 12 but not necessarily on the screen.

As shown in FIG. 2, the probes 14, 16, inductive pickup 28, and the lights 46 may be operatively connected to the controller 50 via internal wires 32 similar to that shown in FIG. 1. The ground connection 34 may be operatively connected to the controller 50 via ground clamp connector 36. The controller 50 may be operatively connected to the wireless communicator 48, the control switches 56, the display 38, the power source 40 or 42, a wired connection 52, and the external device 54 via connectors 44 as shown.

Operation of the glove measuring system 10 may be as follows. The user may put the glove 12 on the user's hand. The user may then use the ground connection 34 to attach or ground the glove 12 by clipping or otherwise attaching the ground connection clip onto an automobile frame or other appropriate ground.

The user may then connect the probes or leads 14 and 16 to respective positive and negative terminals of a device to be tested. Once a contact has been made, signals are relayed to the controller 50. The controller 50 may modify the signal and then cause it to be displayed on the display 38 and/or transmitted to an external device 42.

Manipulation of the switches or controls 56 or a touch screen 38 may allow the user to operate the glove measuring system 10. In some embodiments, the controls 56 may include voice recognition technology in order to allow a user to give oral instructions. Similarly, the system 12 can also broadcast audio readings by electronic voice as well as or instead of displaying data on the display 38. In some embodiments the glove measuring system 10 may perform typical tasks, accomplished by multimeters and or oscilloscopes. The probes 14 and 16 may be used to contact aspects of a vehicle or other device being serviced in order to determine current, voltage, and/or resistance.

In some embodiments, an inductive pickup 28 may be integrated into the glove 12 and allow a user to grab a wire conductor. Once the wire conductor has been grasped by the user wearing the glove 12, the inductive pickup 28 may pick up a reading and send it to the controller 50 which then sends the data either to the display 38 or via the wireless communicator 48 or wired connection 52 to an external device 54. In some embodiments, more probes can be included in the globe 12 and/or more inductive pickups 28 can be used.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A glove comprising:
a palm portion;
first and second fingers extending from the palm portion;
a first probe attached to the first finger;
a second probe attached to the second finger;
connectors contained within the glove operatively connected to the first and second probes; and
a display operatively connected to the first and second probe.

2. The glove of claim 1, further comprising a light attached the glove.

3. The glove of claim 2, wherein the light is an LED light.

4. The glove of claim 1, further comprising an inductive pickup contained within the glove.

5. The glove of claim 4, further comprising a third finger extending from the palm portion wherein the inductive pickup is located in the third finger.

6. The glove of claim 1, further comprising a ground connector configured to attach the glove to a ground.

7. The glove of claim 1, further comprising a power source operatively connected to the first and second probes.

8. The glove of claim 1, further comprising a microcontroller operatively connected to the first and second probes and the display.

9. The glove of claim 8, further comprising a wireless communicator and operatively connected to the microcontroller and configured to transmit data to an external device.

10. The glove of claim 8, further comprising controls operatively connected to the microcontroller and the microcontroller is configured to operate the probes and display as at least one of either a digital micrometer and an oscilloscope.

11. The glove of claim 8, further comprising a connector configured to connect the microcontroller to an external device.

12. The glove of claim 1, wherein the display is a touchscreen display.

13. The glove of claim 1, further comprising a microcontroller configured to at least one of receive oral commands and broadcast audio.

14. A method of assembling an instrument comprising:
attaching a first and second probe to a glove;
connecting the first and second probes to a controller;
operatively connecting a display to the controller;
operatively connecting an input device to the controller; and
configuring the controller to operate the instrument as at least one of either a multimeter and oscilloscope.

15. The method of claim 14, operatively connecting the controller to a wireless communication device.

16. The method of claim 14, wherein the screen is a touch screen and the input device and the display are the same device.

17. The method of claim 14, further comprising operatively connecting a inductive pickup to the controller.

18. The method of claim 14, further comprising grounding the glove.

19. The method of claim 14, further comprising locating the first and second probes in first and second fingers of the glove.

20. A glove comprising:
a palm portion;
first and second fingers extending from the palm portion;
a first probe attached to the first finger;
a second probe attached to the second finger;
means for connecting the first and second probe to a controller, the means for connecting contained within the glove; and
means for displaying data associated with the controller operatively connected to the controller.
